(19) United States
(12) Patent Application Publication
(10) Pub. No.: US 2024/0190186 A1
(43) Pub. Date: Jun. 13, 2024

(54) SYSTEM AND METHOD FOR SETTING TIRE SENSOR IDENTIFICATION CODE

(71) Applicant: Orange Electronic Co., Ltd, TAICHUNG CITY (TW)

(72) Inventor: CHIN -YAO HSU, TAICHUNG CITY (TW)

(21) Appl. No.: 18/365,754

(22) Filed: Aug. 4, 2023

(30) Foreign Application Priority Data
Dec. 13, 2022 (TW) 111147702

(51) Int. Cl. B60C 23/04

(52) U.S. Cl. CPC B60C 23/0442; B60C 23/044; B60C 23/0479

(57) ABSTRACT

A system for setting tire sensor identification code includes a tire sensor, a database and a handheld device. The tire sensor includes an identification code. The database stores vehicle data associated with a code learning method of the identification code of the tire sensor. When the vehicle data is inputted, a link pattern associated with a specific vehicle and a code learning flow of a vehicle computer of the vehicle is generated. The handheld device includes a memory and a link pattern capture module. A plurality of communication protocols are stored in the memory. When the link pattern is captured by the link pattern capture module, one of the communication protocols is selected from the memory and is burned to the tire sensor.

### RELATED APPLICATIONS

This application claims priority to Taiwan Application Serial Number 111147702, filed Dec. 13, 2022, which is herein incorporated by reference.

### BACKGROUND

### Technical Field

The present disclosure relates to a system and method for setting tire sensor identification code.

### Description of Related Art

In order to improve driving safety, most of the existing vehicle tires are equipped with at least one tire sensor (TPMS sensor) that can be used to detect tire status such as tire pressure or temperature, etc. The tire sensor can transmit the tire status to the vehicle computer, thus the driver can immediately know the status of the tires to ensure the safety of driving. However, when an original tire sensor is needed to be replaced with a new one due to power exhaustion, damage or being aged, the vehicle computer is unable to identify the new tire sensor because the vehicle computer is unable to identify the identification code of the new tire sensor. Therefore, the identification code of the new tire sensor must be entered into the vehicle computer in a specific code learning procedure. However, because of wide variety of vehicles, many vehicle manufacturers offer different vehicle models in different years, and for safety concerns, vehicle owners are not allowed to easily set the vehicle computer into the learning mode. Furthermore, the steps to set the vehicle computer into learning mode are different and complex for different vehicle type when it needs to input the identification code of the specific tire sensor in a specific code learning flow into the vehicle computer of a specific vehicle. For example, the operators need to follow the textual instructions to operate different parts of the vehicle to enable the vehicle computer into the code learning mode. Therefore, it is crucial for the operator performing the tire sensor replacement operation to easily know the steps to input the identification code of the specific tire sensor into the specific vehicle computer in a specific code learning flow. For example, when a new tire sensor is installed, a handheld device is operated to select the manufacturer, year and model of the vehicle or to enter the vehicle brand identification number (HSN) and vehicle model identification number (TSN) (HSN and TSN are commonly used in Germany) according to specific vehicle, thus it is capable of selecting an appropriate protocol from many protocols stored in the handheld device, and then burn the protocol to the new tire sensor. It should be noted that the terms “vehicle brand identification number” and “vehicle model identification number” are equivalent to the German terms “Herstellerschlüsselnummer” (abbreviated as HSN) and “Typschlüsselnummer” (abbreviated as TSN), respectively. The aforementioned steps are performed again (e.g., to select the same manufacturer, year and model, or to input the same HSN and TSN from the handheld device), therefore an appropriate operation flow for setting the vehicle computer into the code learning mode can be determined from many operation flows stored in the handheld device for the specific vehicle. And then the textual instructions of the operation flow are displayed on the screen of the handheld device, the operator can follow the textual instructions to operate different parts on the vehicle to set the vehicle computer into the code learning mode (the mode that the identification code of the new tire sensor can be learned), so that the vehicle computer can receive and store the new identification code of the new tire, and the new tire sensor can transmit tire pressure signal (containing the tire sensor identification code) with an appropriate communication protocol to the vehicle computer, and the vehicle computer can recognize the tire pressure signal. Therefore, at least two times of operations (e.g., to select the manufacturer, year and model of the vehicle, or to input the HSN and TSN) are required, and it will take a lot of time.

### SUMMARY

According to one aspect of the present disclosure, a system for setting tire sensor identification code is provided. The system includes a tire sensor, a database and a handheld device. The tire sensor includes an identification code. The database stores vehicle data associated with a code learning method of the identification code of the tire sensor, when the vehicle data is inputted, a link pattern associated with a specific vehicle and a code learning flow of a vehicle computer of the vehicle are generated. The handheld device includes a memory and a link pattern capture module. A plurality of communication protocols are stored in the memory, when the link pattern is captured by the link pattern capture module, one of the communication protocols is selected from the memory and is burned to the tire sensor.

According to one aspect of the present disclosure, a system for setting tire sensor identification code is provided. The system includes a computer and a database. The computer includes a second circuit board. The second circuit board is electrically connected to a second display module, a second operation module and a network module. The database stores a vehicle data associated with a code learning method of an identification code of a tire sensor. The network is connected to the database, when the vehicle data is inputted by the second operation module, a link pattern associated with a specific vehicle is generated and displayed on the second display module, and a code learning flow associated with a vehicle computer of the specific vehicle is generated and displayed on the second display module.

According to one aspect of the present disclosure, a method for setting tire sensor identification code is provided. The method includes: providing a database, wherein the database stores a vehicle data associated with a code learning method of an identification code of a tire sensor; inputting the vehicle data into the database and generating a link pattern associated with a specific vehicle and a code learning flow associated with a vehicle computer of a specific vehicle; capturing the link pattern generated from the database by a handheld device, selecting a communication protocol from a memory of the handheld device and burning the communication protocol to the tire sensor; and executing the code learning flow generated from the database on the vehicle computer of the specific vehicle to enable the vehicle computer to receive the identification code of the tire sensor.

According to one aspect of the present disclosure, a system for setting tire sensor identification code is provided. The system includes a tire sensor, a database and a handheld device. The tire sensor includes an identification code. The database stories a plurality of communication protocols, a code learning flow of a vehicle computer and a vehicle data associated with a communication protocol of the tire sensor, and generates a link pattern associated with a specific vehicle. The handheld device includes a memory and a link pattern capture module. The memory stores a plurality of communication protocols and the code learning flow of the vehicle computer. When the link pattern is captured by the link pattern capture module, one of the communication protocols is selected from the database or the memory and is burned to the tire sensor.

### BRIEF DESCRIPTION OF THE DRAWINGS

The present disclosure can be more fully understood by reading the following detailed description of the embodiment, with reference made to the accompanying drawings as follows:

FIG. 1 is a diagram showing an architecture of a system for setting tire sensor identification codes;

FIG. 2 is a block diagram showing an architecture of the handheld device of FIG. 1;

FIG. 3 is a diagram showing an appearance of a physical product of the handheld device of FIG. 2;

FIG. 4 is a block diagram showing an architecture of a tire sensor;

FIG. 5 is a flow chart showing a method for setting tire sensor identification codes according to one embodiment of the present disclosure;

FIG. 6 is a flow chart showing a OBD code learning flow according to one embodiment of the present disclosure; and

FIG. 7 is a flow chart showing a Tool Trigger code learning flow according to one embodiment of the present disclosure.

### DETAILED DESCRIPTION

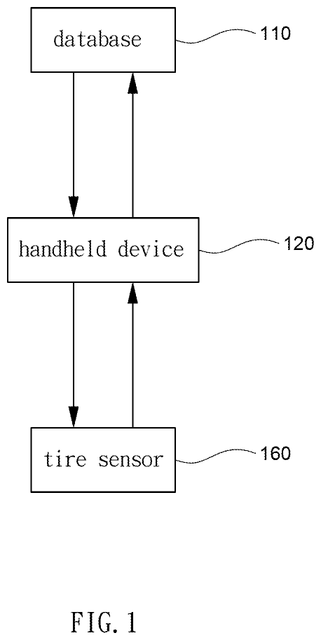

Please refer to FIG. 1. In FIG. 1, a system for setting tire sensor identification code includes a database 110, a handheld device 120 and a tire sensor 160. The tire sensor identification code refers to the identification code of the tire sensor 160 itself. Each tire sensors 160 has a unique identification code. A tire pressure receiver or a vehicle computer can identify each tire sensor 160 through a received tire pressure signal which contains the identification code of each tire sensor 160. The identification code can be any one or a combination of a number, a code or a symbol, and can be used to identify the tire sensor 160.

The database 110 is used to input and store a vehicle data associated with a code learning method of the identification code of the tire sensor 160 and various code learning flows. For example, the code learning flow can be represented in the form of a code learning flow diagram, which means that the code learning flow can be texturized. The code learning flow (i.e., learning flow of the identification code of tire sensor 160) refers to the procedure that setting the vehicle computer into the code learning mode to learn the identification code of the tire sensor 160. When the vehicle is in the code learning mode, the identification code of the tire sensor 160 from the tire sensor 160, the handheld device 120, the database 110 or other devices can be received. The vehicle data can be the manufacturer (brand), model and year of the vehicle (all three of which are abbreviated as MMY) and/or one of the vehicle brand identification number (HSN) and the vehicle model identification number (TSN), where HSN is equivalent to the manufacturer (brand) of the vehicle and TSN is equivalent to the year and model of the vehicle. It should be mentioned that HSN/TSN is commonly used in Germany. Because there are many different vehicle brands on the market, and each of which has different models in different years, there are many different combinations of vehicle data depending on the brand, year and model, therefore the database usually contains a plurality of vehicle data. The above-mentioned database can be used to input and store a plurality of vehicle data associated with different code learning methods of the identification code of the tire sensor 160. Because there are many types of vehicles on the market, each vehicle may have a different method of setting the vehicle computer into the code learning mode, which means that there are many methods that enable the vehicle computer to receive the identification code of the tire sensor 160. Therefore, various code learning flows are stored in the database. When replacing the tire sensor with a new one, it is necessary to select an appropriate protocol to burn into the new tire sensor, so that the new tire sensor can use this protocol to communicate with the vehicle computer or the tire pressure receiver, therefore various communication protocols associated with different vehicle data are also stored in the database. The various vehicle data, communication protocols and code learning flows can also be stored in the memory of the handheld device. The database can be connected to a display screen and an input device (e.g., a keyboard) to input and display the vehicle data, where the database can be a cloud database or data of a remote server. When connected to a desktop or laptop computer via a network and the vehicle data is inputted by the keyboard of the computer, the link pattern and the code learning flow associated with the vehicle data can be displayed on the screen of the computer. The operator can find the appropriate protocol and code learning flow from the database or the memory of the handheld device by simply inputting one type of vehicle data at a time. The link pattern and the code learning flow can be displayed on the same screen, and the screenshot can be saved electronically or printed out by connecting the computer to a printer. On the day of work, the tire factory employee simply takes the computer or printed paper with him and captures the link pattern by the handheld device or mobile phone, and then selects the appropriate code learning flow from the database or the memory of the handheld device to be displayed on the screen of the handheld device or mobile phone. Furthermore, the appropriate code learning flow can be quickly selected from the database or the memory of the handheld device and can be burned to a new tire sensor, thus the vehicle computer can be quickly set into a state where it can receive the identification code of the tire sensor in accordance with the code learning flow, without having to do more complex operations on the handheld device or mobile phone to find the appropriate textual instructions for the code learning mode of the vehicle computer of specific vehicle. Therefore, after capturing the link pattern by the handheld device or mobile phone, finding the appropriate link pattern and code learning flow from the database of the memory, where the link pattern is associated with the communication protocol and the code learning flow. The database may also contain the part number of an old tire sensor as well as the model number and the communication protocol name of a new tire sensor, all of which are associated with the link pattern. The tire sensor will be installed in advance by the vehicle manufacturer before a vehicle out of the factory. After a certain period of time, the tire sensor will be in a low power state or run out of electricity (old tire sensors) and is required to be replaced. Therefore, in the after-market (AM), there are tire sensor manufacturers who manufacture tire sensors (new tire sensors) to replace the old ones. The tire sensor manufacturers will know through market research, that which part number of tire sensors will be installed to a specific vehicle of a vehicle manufacturer, therefore the tire sensor manufacturers can input and store the part number in the database of the tire sensor manufacturers. The tire sensor manufacturers will also know which tire sensor model (new tire sensor) and communication protocol will be appropriate for a specific vehicle of a vehicle manufacturer and can therefore input and store the appropriate tire sensor model and communication protocol name in the database of the tire sensor manufacturers. Therefore, when the employee of the tire factory inputs the vehicle data by the keyboard of the computer, not only the link pattern and the code learning flow are displayed on the screen of the computer, but also the part number of the old tire sensor, the model of the new tire sensor and the communication protocol name are displayed on the screen of the computer. On the day of work, when the employee uses a handheld device or a mobile phone to capture the linking pattern, the code learning flow, the part number of the old tire sensor, the model number of the new tire sensor and the communication protocol name will be displayed on the screen of the handheld device or the mobile device. Therefore, the new tire sensor with appropriate model number can be quickly retrieved from the stock according to the part number of the old tire sensor. After a period of time, when the new tire sensor is needed to be replaced, the employee will be able to quickly find out from the database that which model number of the original tire sensor is installed for subsequent replacement work.

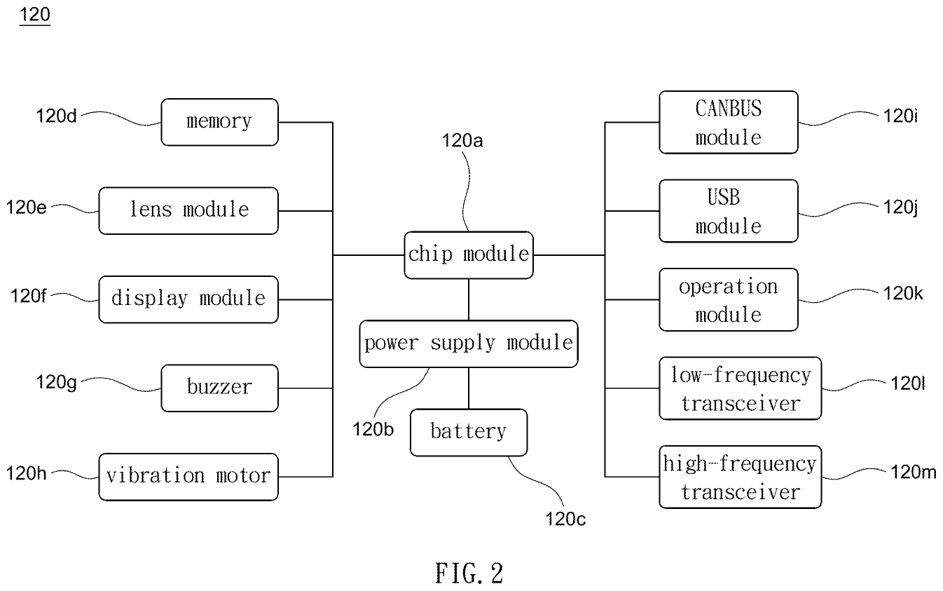

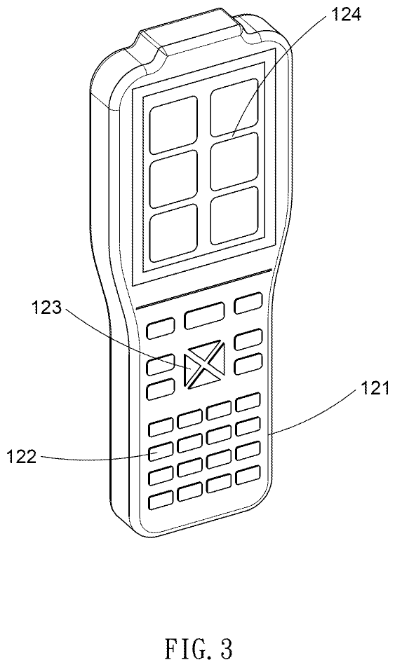

The handheld device 120 is primarily a handheld tool that can be used independently from the vehicle. The handheld device 120 can be carried and used by a user at any predetermined place. In the embodiment of the present disclosure, the handheld device 120 can be a tire sensor setting tool, as shown in FIGS. 2 and 3. The handheld device 120 is commonly manufactured or sold by a tire pressure sensor manufacturer. The handheld device 120 can include a circuit board and a chip module 120a installed thereon. The chip module 120a is a control center, a power supply module 120b, a memory 120d, a lens module 120e, a display module 120f, a buzzer 120g, a vibration motor 120h, a controller area network (CANBUS) module 120i, a USB module 120j, an operation module 120k, a low-frequency (125 KHz) transceiver 120l, a high-frequency (315 MHz/433 MHZ) transceiver 120m, a first Bluetooth module, a radio frequency identification (RFID) writer 120n can be electrically connected to the chip module 120a and are controlled by the chip module 120a. Furthermore, when the handheld device 120 is a tire sensor setting tool, it has a low-frequency (125 KHz) transceiver 120l and can transmit a low-frequency (LF) signal to the tire sensor 160. The handheld device 120 also has a high-frequency 315 MHz/433 MHz) transceiver 120m, and the high-frequency transceiver can be used to receive high-frequency tire pressure signal from the tire sensor 160. In this situation, the handheld device 120 cannot be a mobile phone, a tablet or a laptop, owing to the mobile phone, the tablet or the laptop doesn't have the low-frequency (125 KHz) transceiver 120l and the high-frequency (315 MHz/433 MHz) transceiver 120m.

The chip module 120a has logic operation functionalities and integrates with a wireless communication chip. The chip module 120a can exchange data with external devices through various communication protocols (e.g., Wi-Fi, Bluetooth, 3G, 4G, 5G or 6G, etc.). For example, the data can be exchanged with a remote server through a Wi-Fi protocol, or can be exchanged with a mobile phone with a Bluetooth protocol. A Wi-Fi module and the first Bluetooth module can be used independently from the chip module 120a or can be integrated in the chip module 120a. The network module of the handheld device 120 can be a controller area network (CANBUS) module 120i or a wireless communication chip. The handheld device 120 can be connected to the database or computer by the wireless communication chip or the controller area network (CANBUS) module 120i. When an operator inputs a vehicle data by the handheld device 120 or the mobile phone, a link pattern associated with a specific vehicle and a code learning flow associated with the specific vehicle is generated are generated. Furthermore, when the link pattern is captured by the handheld device 120 or the mobile phone, an appropriate communication protocol and an appropriate code learning flow will be found out from the memory 120d of the handheld device 120 or the database.

The power supply module 120b provides necessary power for hardware operation. In one example, the power supply module 120b can use a battery 120c as a power source, but it is not limited herein.

The memory 120d can store data and several communication protocols, software programs can be loaded into the memory 120d to process vehicle service information and tire operation information. The vehicle service information can include a tire buyer name, a tire seller name, a tire buyer address, a tire seller address, a tire identification (ID), etc., and the tire operation information can include a tire pressure, a tire temperature, a tire sensor electricity, a tire sensor identification code, a vehicle owner information, etc. The vehicle owner information can include a license plate number or a vehicle identification number (VIN), etc. The vehicle service information can be associated with the link pattern and the code learning flow. For example, when a used tire sensor is needed to be replaced by a new one, the vehicle owner information can be inputted into the computer, mobile phone or handheld device 120, and the link pattern and code learning flow associated with the vehicle can be generated, and it is not necessary to input MMY or HSN/TSN again by the mobile phone or handheld device 120.

The lens module 120e can be equipped with a lens assembly to scan or take pictures of a bar code, a QR code or a number on the tire skin. The number on the tire skin can be the tire ID. After scanning or taking pictures of the license plate number through the lens module 120e, photos are transmitted to the chip module 120a, and then an image recognition software can be used to identify the photos, thus the tire ID can be known.

The display module 120f can display a touch input interface. A vehicle information, a tire information and a vehicle service information can be inputted through the touch input interface. The vehicle information can include a license plate number, a vehicle model number, etc. The tier information can include tire model number, tire size and tire installation location, etc. The display module 120f can also be a non-touch input screen.

The low-frequency (125 KHz) transceiver 120l can transmit a trigger signal to the tire sensor 160, and the tire sensor 160 transmits an operation message back after receiving the trigger signal. The low-frequency (125 KHz) transceiver 120l can be a low-frequency (125 KHz) transceiver circuit.

The high-frequency (315 MHz/433 MHZ) transceiver 120m can receive the operation messages, and process the operation messages and the vehicle owner information through the software program stored in the memory 120d. The chip module 120a executes instructions of the software program. The instructions of the software program include: generating a user profile to store operation information; transmitting the operation information and the vehicle owner information to the database 110 through the chip module 120a; and transmitting the vehicle owner information through the low-frequency (125 KHz) transceiver 120l. The high-frequency (315 MHz/433 MHZ) transceiver 120m can be a high-frequency (315 MHz/433 MHz) transceiver circuit.

The controller area network (CANBUS) module 120i is connected to a receiving device of the vehicle. The receiving device can be a computer built in the vehicle, or can be an external stand-alone device that can connect to the car computer wirelessly or through a cable (plug into the cigarette hole).

The universal serial bus (USB module) 120j can be wired to external mobile phones or computers.

The operation module 120k can be used to confirm function using operating buttons or knobs, and can be used to input the vehicle service information, basic information, etc.

The buzzer 120g and the vibration motor 120h can generate sound or vibration for warning when an error occurs.

Furthermore, the above handheld device 120 can include a slot. An additional memory (e.g., SD card) can be inserted into the slot for storing the operation information or the vehicle service information.

As shown in FIG. 3, the handheld device 120 can include a grip 121, a button 122 (acted as a confirmation button or a return button), a function selection key 123 and a touch input interface 124. The button 122 and the function selection key 123 can be incorporated with software programs to perform different functions, a port can be connected to the external mobile phone or computer. One slot of the handheld device 120 can be equipped with an additional memory (e.g., SD card). The physical product structure of the handheld device 120 of the present disclosure is not limited to the above embodiments, it can also have other kinds of physical product structure.

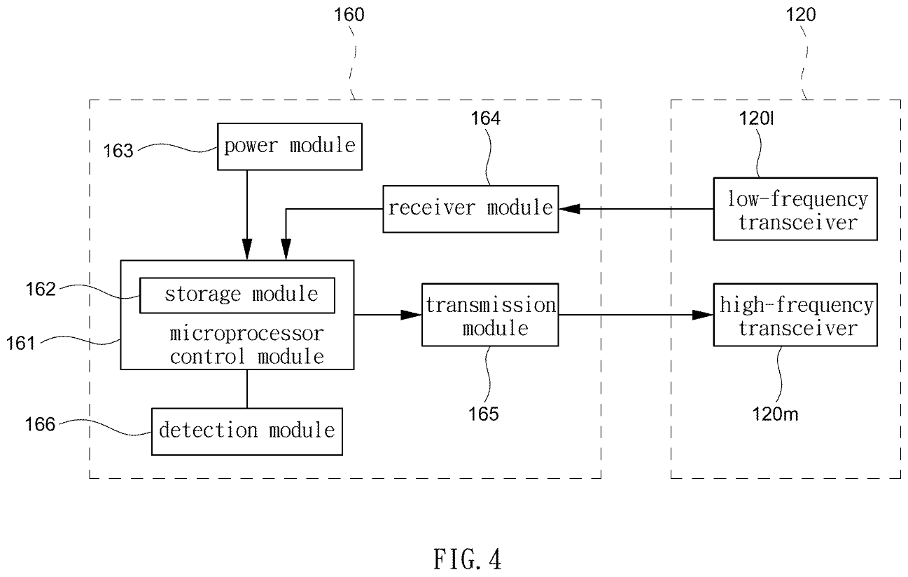

Please refer to FIG. 4, the tire sensors 160 can include a storage module 162 and a receiver module 164. The storage module 162 can store the operational information. The receiver module 164 is electrically connected to the storage module 162, and can receive a vehicle service information, and the storage module 162 stores the vehicle service information. The tire sensor 160 can further include a microprocessor module 161, a power module 163, a transmission module 165, a detection module 166, a second Bluetooth module. The power module 163, the transmission module 165, the receiver module 164, the second Bluetooth module and the detection module 166 are electrically connected to the microprocessor module 161. Each tire sensors 160 has a unique identification code, the tire pressure receiver or the vehicle computer can identify each tire sensor 160 through a received tire pressure signal which contains the identification code of each tire sensor 160. The storage module 162 can be a readable and writable memory. The receiver module 164 can be a receiver circuit. The transmission module 165 can be a transmission circuit. The detection module 166 can be a tire pressure sensor, a tire temperature sensor or an acceleration sensor. The second Bluetooth module can be a Bluetooth circuit. The second Bluetooth module can be used independently of the microprocessor module 161, or can be integrated in the microprocessor module 161.

The transmission module 165 can transmit a high frequency (315 MHz/433 MHZ) pressure signal to the high frequency (315 MHz/433 MHz) transceiver 120m of the handheld device 120. The receiver module 164 can receive a low-frequency signal (e.g., containing the communication protocol to be burned) transmitted from the low-frequency (125 KHz) transceiver 120l of the handheld device 120. The second Bluetooth module can also transmit a tire pressure signal to the first Bluetooth module, and the first Bluetooth module can transmit the communication protocol to be burned to the second Bluetooth module.

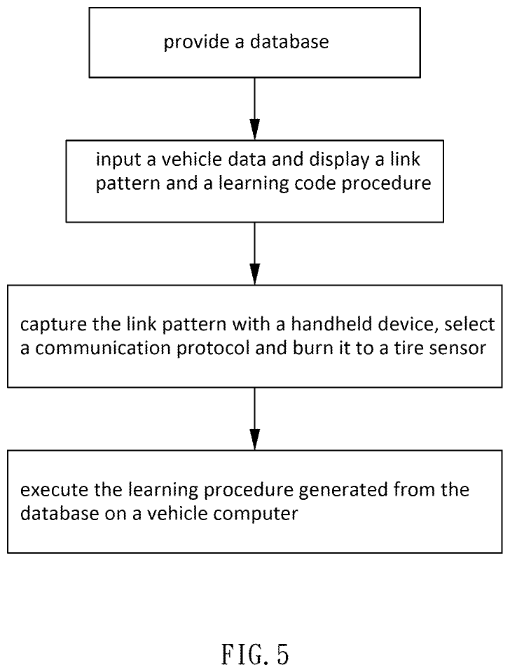

Please refer to FIG. 5, a method for setting tire sensor identification code of the present disclosure includes the following steps:

Providing a database, wherein the database stores vehicle data associated with a code learning method of an identification code of a tire sensor. The vehicle data can include a manufacturer, a year, a model, and/or a vehicle brand identification number HSN and a vehicle model identification number TSN of the vehicle.

Inputting the vehicle data into the database, the vehicle data can be one of the manufacturer, the year, the model, and/or the vehicle brand identification number HSN and the vehicle model identification number TSN of the vehicle. While HSN or TSN is only used in Germany, a HSN or TSN can be selected or inputted, and the manufacturer, year and model of the vehicle are also used. In other countries, the manufacturer, year and model of the vehicle are used. And then the link pattern associated with a specific vehicle is generated from the database, and the code learning flow of the vehicle computer of the specific vehicle is also generated. The vehicle computer must be in a code learning mode to receive an identification code of a new tire sensor 160. The link pattern can be a bar code, a QR code, tec. The code learning flow can be an On-Board Diagnostic (OBD) code learning flow, an automatic code learning flow, a tool trigger code learning flow (TOOL trigger) or a pressure relief code learning flow. In the OBD code learning flow, a handheld device is wired into the vehicle's OBD to transmit the identification code to the vehicle computer. In the automatic code learning flow, the handheld device is no required, when the vehicle has been driven for a certain period of time, the vehicle computer automatically receives the identification code of the tire sensor. Because there is an acceleration sensor built in the tire sensor, when the tire rotates, the acceleration sensor detects the acceleration in different directions, and the tire sensor is triggered to transmit the identification code to the vehicle computer. In the tool trigger code learning flow, the handheld device transmits a signal to trigger the tire sensor wirelessly, and the tire sensor transmits an identification code to the vehicle computer. In the pressure relief code learning flow, the tire sensor detects a reduction in tire pressure due to a tire pressure leak and the tire sensor is triggered to transmit an identification code to the vehicle computer.

Capturing the link pattern by the handheld device, selecting a communication protocol from the memory of the handheld device and burning the communication protocol to the tire sensor.

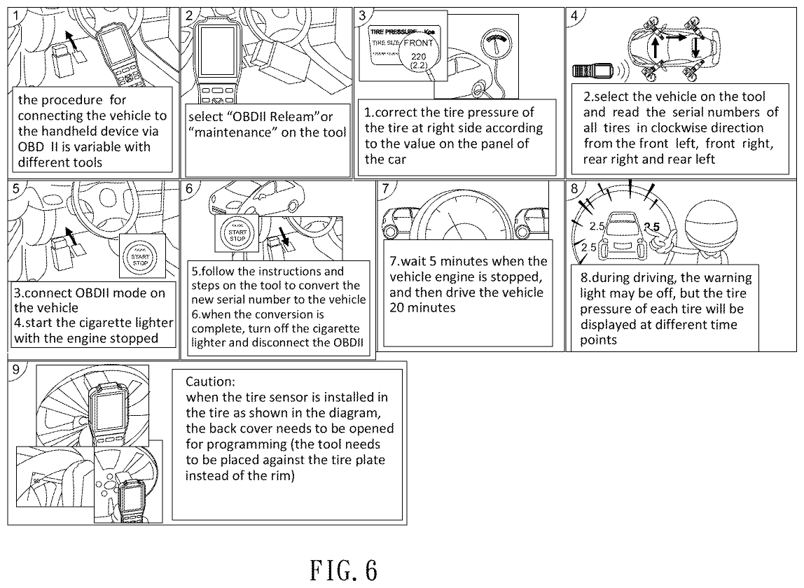

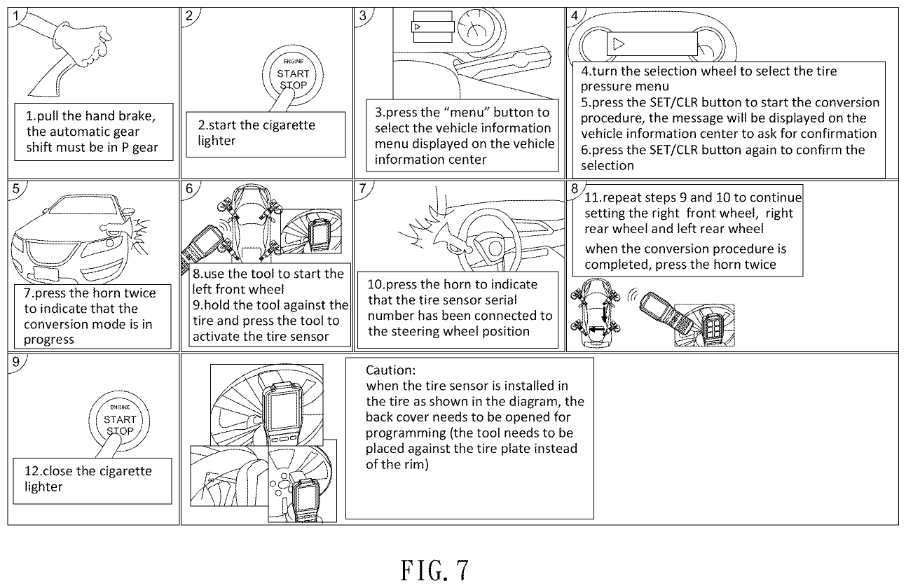

Executing the code learning flow generated from the database on the vehicle computer of the specific vehicle to enable the vehicle computer to receive and recognize the identification code of the tire sensor. For example, FIG. 6 shows a OBD code learning flow and FIG. 7 shows a tool trigger code learning flow.

The advantages of the present disclosure are as follows:
1. In the conventional arts, it needs to sequentially input or select the manufacturer, year, model and/or HSN/TSN of the vehicle on different display screens of the handheld device 120, and then select an appropriate communication protocol and burn it into the tire sensor 160, and then sequentially input or select the manufacturer, year, model and/or HSN/TSN of the vehicle by the handheld device 120 again to generate a textual instruction of an appropriate code learning flow, and then operator can follow the textual instruction to operate different parts on the vehicle, thus setting the vehicle computer into a code learning mode. In the present disclosure, various code learning flow diagrams and vehicle data are pre-stored in the database 110. The link pattern and the appropriate coding learning flow diagram can be obtained by simply inputting the manufacturer, year, model and/or HSN/TSN of the vehicle. And then the link pattern and the appropriate code learning flow diagram can be stored in the database 110 or in a computer, or the link pattern and the code learning flow diagram can be printed out. As long as the mobile phone or the handheld mobile device 120 having a link pattern capture module captures the link pattern, it is possible to quickly select the appropriate protocol from the memory of the mobile phone or the handheld mobile device 120 and quickly set up the vehicle computer with reference to the code flow pattern, and the time that selecting the manufacturer, year and model and/or HSN/TSN of the vehicle separately and twice in the conventional arts can be reduced.
2. In the conventional art, the communication protocol and the textual instructions of the code learning flow are only obtained by selecting the manufacturer, year and model and/or HSN/TSN of the vehicle twice on the handheld device, and the results are only stored in the handheld device. In the present disclosure, the manufacturer, year and model and/or HSN/TSN of the vehicle only required to be selected once in the database 110, the link pattern and the code learning flow diagram will be displayed on the screen of the computer. Any electronic device having a link pattern capture module can immediately capture the link pattern and quickly obtain the appropriate protocol from the memory of the electronic device for burning and setting the vehicle computer according to the code learning flow diagram. Therefore, it is much easier to use the communication protocols and the code learning flow.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A system for setting tire sensor identification code, comprising:
a tire sensor comprising an identification code;
a database storing vehicle data associated with a code learning method of the identification code of the tire sensor, when the vehicle data is inputted, a link pattern associated with a specific vehicle and a code learning flow of a vehicle computer of the specific vehicle are generated; and
a handheld device comprising a memory and a link pattern capture module, wherein a plurality of communication protocols are stored in the memory, when the link pattern is captured by the link pattern capture module, one of the communication protocols is selected from the memory and is burned to the tire sensor.

2. The system of claim 1, wherein the vehicle data comprises one of a manufacturer, a year, a model, and/or a vehicle brand identification number (HSN) and a vehicle model identification number (TSN) of the vehicle.

3. The system of claim 1, wherein the link pattern is associated with the communication protocol and the code learning flow.

4. The system of claim 2, wherein the handheld device comprises:
a first circuit board;
a chip module installed on the first circuit board;
a power supply module;
a memory;
an operation module;
a controller area network module;
wherein the power supply module, the memory, the operation module and the controller area network module are electrically connected to the chip module and are controlled by the chip module.

5. The system of claim 3, wherein the link pattern capture module is a lens module, when the link pattern is captured by the lens module, the communication protocol is selected from the memory and the code learning flow is generated from the database.

6. The system of claim 4, wherein the handheld device further comprises:
a Wi-Fi module;
a first Bluetooth module;
a display module;
a USB module;
a low-frequency (125 KHz) transceiver; and
a high-frequency (315 MHz/433 MHz) transceiver;
wherein the Wi-Fi module, the first Bluetooth module, the display module, the USB module, the low-frequency (125 KHz) transceiver and the high-frequency (315 MHz/433 MHz) transceiver are electrically connected to the chip module and are controlled by the chip module.

7. The system of claim 1, wherein the tire sensor comprises:
a storage module:
a receiver module electrically connected to the storage module;
a microprocessor module;
a power module;
a transmission module; and
a detection module;
wherein the receiver module, the power module, the transmission module and the detection module are electrically connected to the microprocessor module.

8. The system of claim 1, wherein when the vehicle computer of the specific vehicle executes the code learning flow, the vehicle computer of the specific vehicle receives the identification code of the tire sensor.

9. The system of claim 1, wherein the database further stores a part number and a model number of an old tire sensor, and the part number and the model number are associated with the link pattern.

10. A system for setting tire sensor identification code, comprising:
a computer comprising a second circuit board, wherein the second circuit board is electrically connected to a second display module, a second operation module and a network module; and
a database stores vehicle data associated with a code learning method of an identification code of a tire sensor;
wherein the network module is connected to the database, when the vehicle data is inputted by the second operation module, a link pattern associated with a specific vehicle is generated and displayed on the second display module, and a code learning flow associated with a vehicle computer of the specific vehicle is generated and displayed on the second display module.

11. The system of claim 10, wherein the computer is connected to a printer, the printer prints the link pattern and the code learning flow.

12. The system of claim 10, further comprising a handheld device, wherein the handheld device comprises a memory and a link pattern capture module, a plurality of communication protocols are stored in the memory, when the link pattern is captured by the link pattern capture module, one of the communication protocols is selected from the memory and is burned to a tire sensor.

13. The system of claim 10, wherein when the vehicle computer of the specific vehicle executes the code learning flow, the vehicle computer of the specific vehicle receives the identification code of the tire sensor.

14. A method for setting tire sensor identification code, comprising:
providing a database, wherein the database stores vehicle data associated with a code learning method of an identification code of a tire sensor;
inputting the vehicle data into the database and generating a link pattern associated with a specific vehicle and a code learning flow associated with a vehicle computer of the specific vehicle;
capturing the link pattern generated from the database by a handheld device, selecting a communication protocol from a memory of the handheld device and burning the communication protocol to the tire sensor; and
executing the code learning flow generated from the database on the vehicle computer of the specific vehicle to enable the vehicle computer to receive the identification code of the tire sensor.

15. The method of claim 14, wherein the vehicle data comprises one of a manufacturer, a year, a model, and/or a vehicle brand identification number (HSN) and a vehicle model identification number (TSN) of the vehicle.

16. The method of claim 14, wherein the code learning flow of the vehicle computer comprises a OBD code learning flow, an automation code learning flow, a tool trigger code learning flow or a pressure relief code learning flow.

17. The method of claim 14, wherein the database further stores a part number and a model number of an old tire sensor, and the part number and the model number are associated with the link pattern.

18. A system for setting tire sensor identification code, comprising:
a handheld device comprising a first circuit board, a chip module installed on the first circuit board, a memory, a link pattern capture module, a low-frequency (125 KHz) transceiver and/or a first Bluetooth module;
wherein the memory, the link pattern capture module, the low-frequency (125 KHz) transceiver and/or the first Bluetooth module are electrically connected to the chip module and are controlled by the chip module, a plurality of communication protocols are stored in the memory, when a link pattern generated from a database is captured by the link pattern capture module, one of the communication protocols is selected from the memory and is burned to a tire sensor by the low-frequency (125 KHz) transceiver or the first Bluetooth module;
wherein the tire sensor comprises a microprocessor module, a storage module, a receiver module and/or a second Bluetooth module, the storage module, the receiver module and/or the second Bluetooth module are electrically connected to the microprocessor module and are controlled by the microprocessor module, and the communication protocol is received by the receiver module or the second Bluetooth module and is stored in the storage module.

19. The system of claim 18, wherein the database stores a code learning flow of a vehicle computer and a vehicle data, when the vehicle data is inputted into the database, the link pattern and the code learning flow of the vehicle computer are generated at the same time.

20. A system for setting tire sensor identification code, comprising:
a tire sensor comprising an identification code;
a database storing a plurality of communication protocols of the tire sensor, code learning flows of a vehicle computer and vehicle data associated with the communication protocols of the tire sensor, and generating a link pattern associated with a specific vehicle after inputting the vehicle data; and
a handheld device comprising a memory and a link pattern capture module, wherein the memory stores a plurality of communication protocols and code learning flows of the vehicle computer, when the link pattern is captured by the link pattern capture module, one of the communication protocols is selected from the database or the memory and is burned to the tire sensor.

21. The system for claim 20, wherein one of the code learning flows is selected from the database or the memory, and the vehicle computer receives the identification code of the tire sensor in accordance with the selected code learning flow.

22. The system of claim 20, further comprising a computer, wherein the vehicle data is inputted by the computer or the handheld device.
